(19) United States
(12) Patent Application Publication
(10) Pub. No.: US 2019/0361713 A1
(43) Pub. Date: Nov. 28, 2019

(54) AUTOMATED PARKING METER MAINTENANCE SYSTEMS AND METHODS

(71) Applicant: Municipal Parking Services, Inc., Minnetonka, MN (US)

(72) Inventors: Richard W. KELLEY, II, Corcoran, MN (US); James Paul MARTIN, Vadnais Heights, MN (US); Jacob P. ELMS, Brooklyn Center, MN (US)

(21) Appl. No.: 16/421,297

(22) Filed: May 23, 2019

Related U.S. Application Data
(60) Provisional application No. 62/675,449, filed on May 23, 2018.

(51) Int. Cl. G06F 9/445; G06Q 10/00; G01V 11/00; H04L 29/08

(52) U.S. Cl. CPC G06F 9/44505; H04L 67/10; G01V 11/002; G06Q 10/20

(57) ABSTRACT

A self-diagnostic and automated monitoring and maintenance system for use with parking meter systems. The maintenance system improves functionality, and detects and mitigates unexpected behavior and errors with parking meters. In order for a parking meter to seamlessly function during inoperable situations with respect to municipality regulations, automated self-diagnosis coupled with an enforcement policy configuration can be utilized to mitigate unexpected behaviors.

### PRIORITY

This Application claims priority to and the benefit of U.S. Provisional Patent Application No. 62/675,449, filed May 23, 2018, which is incorporated fully herein by reference.

### FIELD

The present invention relates generally to parking systems and, more particularly, to a parking meter monitoring system including self-diagnosis and automated maintenance software and features.

### BACKGROUND

Parking meters can have both internally and externally induced failures that render them partially or completely inoperable. In such cases, users can encounter unexpected meter behaviors, which can trigger unknown municipality enforcement policies—e.g., potential ticketing. Conventional meters do not have contingency policies in place to determine the specifics of the failures or errors.

Additionally, a meter outage remains unresolved until a user complaint is lodged, or a manual determination is made by municipality service personnel. This is highly inefficient and will likely result in increased meter downtime or periods of defective operation.

As such, there is a need for new and improved systems and methods of automatically monitoring and addressing parking meter behavior and maintenance needs.

### SUMMARY

The present invention provides unique devices, systems, and methods for improving functionality and for detecting and mitigating unexpected behavior and errors with parking meter systems. In order for a parking meter to seamlessly function during inoperable or undesirable situations with respect to municipality regulations, automated self-diagnosis coupled with an enforcement policy configuration can be utilized to mitigate unexpected behaviors.

In certain embodiments, the present invention includes an automated parking meter monitoring system comprising at least one parking meter including non-transitory memory, a processor operably coupled with the non-transitory memory, and one or more meter devices. Further, an application policy database or table is provided and includes one or more maintenance mode instructions or directives. Maintenance software is configured to monitor the operation state of the one or more meter devices and retrieve and process the one or more maintenance mode instructions from the application policy table based on the operation state of the one or more meter devices of the parking meter.

The input or meter devices of the parking meter can include power sources (primary or secondary), communication channels (e.g., wireless, cellular, broadband, ethernet, etc.), touch screen overlays, LCD screen displays, home or meter buttons/inputs, accelerometers, temperature sensors, scanners, network interfaces, power rail monitors, and a myriad of other inputs registerable and in communication with the maintenance monitor to trigger automatic maintenance modes based on the updatable configuration table for a correct user experience.

Different meter device outages or errors can produce various behaviors (internal or external) or outputs, such as informing users how to proceed with their use of the meter—e.g., park for free, no parking, etc. Additionally, service personnel can clear or otherwise interact with maintenance monitor modes, by parking space, through the use of cloud backend or direct interfaces with the meter.

The parking meter can include a user screen for use via administrative access to place any or all of the managed spaces into maintenance mode. The meter software access can also be facilitated via remote (e.g., wired or wireless connectivity) devices or computing systems provided in operable communication with the meters.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 shows a diagram of various smart parking meter system components, in accordance with embodiments of the present invention.

FIG. 2 shows a diagram of various components of an integrated parking system, in accordance with embodiments of the present invention.

FIG. 3 shows a diagram of a self-diagnostic and automated maintenance system for a parking system, in accordance with embodiments of the present invention.

FIG. 4 shows a flow chart of a maintenance application operation and process, in accordance with embodiments of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

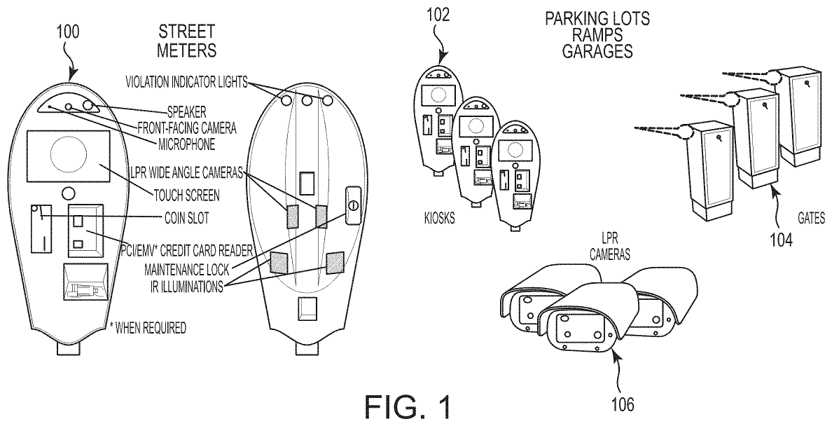

Referring to FIG. 1, various components of a smart parking system are shown. Smart parking meters 100, such as those disclosed in U.S. Pat. Pub. Nos. 2014/0214499 A1 and 2014/0214500 A1 (which are both incorporated herein by reference in their entirety), can be deployed adjacent to various parking spaces. Such smart meters provide for smart parking monitoring where the meters can detect the presence of a vehicle in a parking space, determine the identity of the vehicle, permit the parking user to pay for parking, determine parking violation notices, and other intelligent functions. Each of the meters 100 is also networked with a central or control computer 108 for added control and functionality.

Each smart parking meter 100 includes a processor and physical memory coupled to the microprocessor. A computer readable program code can be stored in the physical memory (e.g., random access memory, flash memory, solid-state storage, hard drive, etc.) of the meter. The computer readable program code is configured such that when executed by the microprocessor, the code causes the meter to perform the steps of the invention described herein.

The same or similar smart parking meter 100 can also be configured as a kiosk 102 and placed adjacent a parking lot or ramp. The kiosk 102 is coupled to gates 104 and/or license plate reading (LPR) cameras 106 to monitor parking events at a lot, ramp or garage, and to control the flow of vehicles into and out of the parking facility.

A kiosk 102 can also simultaneously function as a parking meter 100. A single kiosk or meter 102 can further be coupled to one or more LPR cameras 106 that each monitor individual parking spaces so that the single kiosk or meter 102 monitors multiple individual parking spaces or events.

Note that when the term “meter” is used throughout this application, such use should be understood to include both smart meters 100 and kiosks 102.

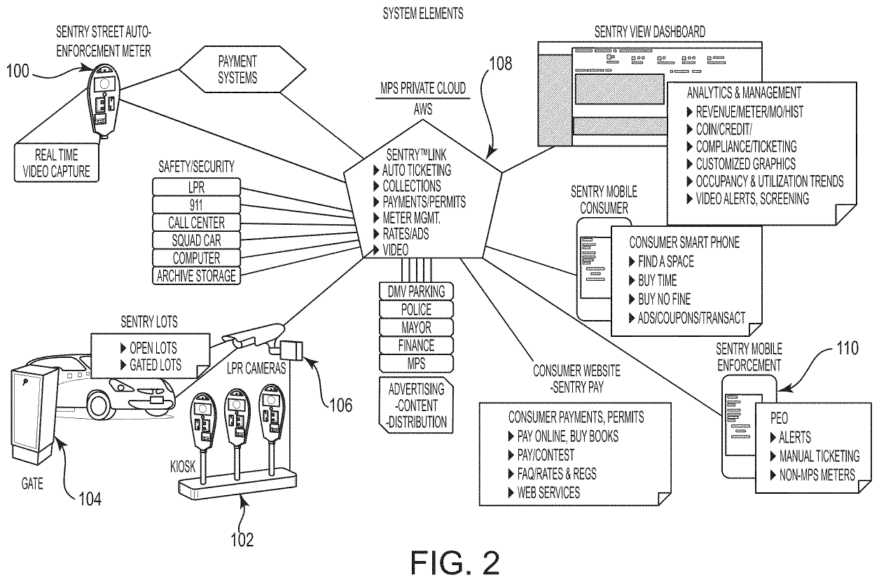

Referring to FIG. 2, each meter 100 and kiosk 102 is communicatively coupled or networked to the so-called cloud computing system 108 via the internet or other wired or wireless connection. The cloud computing system 108 can also be referred to as one or more central or control computers or servers.

The cloud computing system 108 comprises one or more computer systems located remotely and is networked with the meters 100 and kiosks 102. The network can be wired or wireless, and the network can be either a private network (e.g., local area network or LAN) or a public network such as the world wide web (e.g., the Internet).

Computing devices 110 such as smart phones, tablet computers, laptops and personal computers can communicate with the meters 100 and kiosks 102 via the cloud server 108, or directly. The computing device 110 includes a microprocessor, physical memory coupled to the microprocessor, a graphical user interface, an input device (e.g., keyboard, mouse, voice commands/input, and/or touch-sensing display screen) and a network interface coupled to the microprocessor. The physical memory can be a non-transitory memory.

The network interface is configured to enable communication with a communication network (e.g., the Internet), using a wireless connection (e.g., cellular such as LTE, Wi-Fi, etc.).

The memory in the user's computing device 110 may include one or more non-volatile storage devices and/or one or more volatile storage devices (e.g., random access memory (RAM)).

In various embodiments, the code for various software applications reside in the non-volatile memory of a central server, or on the meter itself. Each meter 100 is in communication with the cloud system 108.

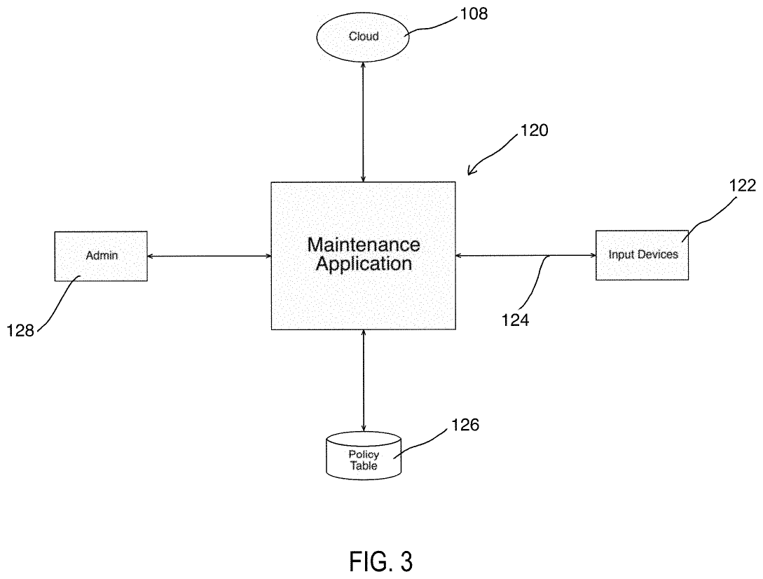

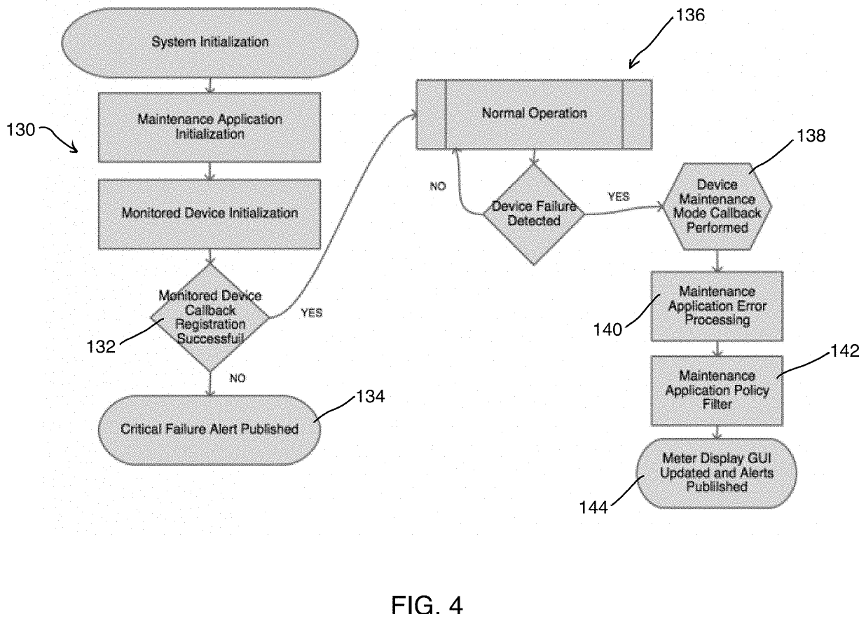

Referring now to FIGS. 3-4, an automated self-diagnosis maintenance application and system 120 of the present invention will be detailed. The maintenance application 120 can be embodied in one or more software applications running on various computing devices or systems, including computer hardware provided with the meter 100 and/or at least partially with the cloud system 108.

The application 120 (e.g., a maintenance monitor) can enumerate all associated meter devices (such as input devices) provided, or in operable communication, with a corresponding meter 100. These meter devices or meter input devices 122 can receive inputs or input data 124 from a myriad of sources, including but not limited to buttons or keys, computing and meter hardware components. power supply components, vehicle and object scanning or sensing components, wired or wireless communication systems or devices, touch inputs, payment acceptors such as coin acceptors or card readers, sensors (e.g., temperature, weather, etc.), audio or video input devices, user inputs, or any other internal or external meter inputs or features. The application 120 registers event callbacks for each input device function in terms of operability—e.g., proper or expected operation of the respective device.

During the operation of these meter devices 122, events are generated and captured by maintenance monitor callback handlers, thereby keeping state on each device function's operability state. When a meter device 122 sources an event that indicates a fault, or discontinues sourcing normal behavior events (e.g., detected through use of timers), a policy based table or database 126 is accessed to provide directives or instructions to be carried out for continued operation or repair. With certain embodiments, the directives can include the following: user screen display messaging (including parking space rate information, e.g., free or no parking), informational lighting, payment acceptance, alerting through backend interfaces (e.g., cloud-based) to communicate the nature of the outage to service personnel, and the like. The policy-based table 126 is pre-populated with information and data that defines the device 122 necessity and outage recognition and severity.

As shown in FIG. 4, the system and other corresponding software applications, such as the maintenance application 120 and the monitored device 122, are initialized (step 130) and it is determined if the monitored device 122 callback registration is successful (step 132). If it is unsuccessful, a critical failure alert is outputted or published at step 134. If the callback is successful, a “normal operation” verification is performed at step 136. If a device 122 failure is detected, the device maintenance mode is performed at step 138, the maintenance application error is processed at step 140, the maintenance application policy filter 126 is employed at step 142, and the meter display (e.g., via GUI interface, visual outputs, etc.) is updated with the appropriate outputs and alerts at step 144.

Different device outages can produce various behaviors (internal or external) or outputs, such as informing users how to proceed with their use of the meter—e.g., park for free, no parking, etc. Each parking space managed by the parking meter 100 and its maintenance application 120 can be discretely state driven in cases where that spot could be in either an operational mode or a maintenance mode. If the device 122 were to “self-clear” and become operational through use of internal computing processes or methods, or corrected in a service action, normal behavior events would be sourced to the maintenance monitor event callback. This, in turn, would automatically clear that device function's state back to “normal” and could initiate external state indicators, such as display outputs, audio outputs, lighting outputs, etc.

Additionally, service personnel can clear or otherwise interact with maintenance monitor modes, by parking space, through the use of cloud backend or direct interfaces with the meter 100 and maintenance application 120—e.g., operably connected to the device's network or service menu, which can be accessed via the meter's user interface. Device operational state alerting can be sent through the cloud backend interfaces for direct or remote monitoring and control.

Along with self-diagnostic monitoring, the parking meter 100 includes a user screen for use via administrative access 128 to place any or all of the managed spaces into maintenance mode. The meter software access can also be facilitated via remote (e.g., wired or wireless connectivity) devices or computing systems provided in operable communication with the meters 100. An administrative user can authenticate, select the maintenance screen and software, and then choose or select a spot and maintenance mode type (e.g., free, no parking, maintenance, unenforced, etc.). Alternatively, an administrative user can take the meter 100 or any of its parking spots out of maintenance mode through the interface and corresponding input selections.

As an example, a parking meter 100 can include a coin acceptor which is an enumerated device 122, thereby registering function callbacks for all events. If the coin acceptor 122 were to become jammed during use, a generated event is received by the maintenance application 120, indicating the outage or error. Based on configured and stored policy parameters in the database 126, the event may trigger the parking meter 100 to no longer allow coin acceptance, and only allowing credit card payments and/or placing the subject parking meter 100 in a free or no parking mode, unenforced (revenue accepting but non-ticket issuing) mode, maintenance mode, etc. This implementation allows unknowing users to utilize the meter 100 as the municipality or technician works on the issue during the inoperable period. Similarly, if the coin jam were to self-clear as coin acceptance continued, the maintenance monitor 120 would take the meter 100 out of the pre-configured maintenance mode, thereby placing the meter 100 back into normal service without human involvement. Similarly, the above-referenced steps and protections can occur when a credit card reader on a meter 100 is indicated to have an outage or error, in addition to a myriad of other meter device 122 outages, errors, and other operation states and changes.

Further, the parking meter's vehicle detection sensors 122 can be enumerated and register function callbacks. If these sensors fail or produce an out-of-range value, for instance, an error event is generated, which performs the callback and triggers a maintenance mode based on the municipality's desired configuration provided with the database 126.

It should be noted that other registered functions and recognized maintenance events in addition to coin or payment acceptor errors are envisioned for monitoring and addressing with the application 120 of the present invention. For each meter 100 and the other components or aspects of the meter system, the input or meter devices 122 can include power sources (primary or secondary), communication channels (e.g., wireless, cellular, broadband, ethernet, etc.), touch screen overlays, LCD screen displays, home or meter buttons/inputs, accelerometers, temperature sensors, scanners, network interfaces, power rail monitors, and a myriad of other inputs 122 registerable and in communication with the maintenance monitor 120 to trigger maintenance modes based on the updatable configuration table 126 for a correct user experience.

As detailed above, various computing devices or systems can be included and adapted to process and carry out the aspects, computations, storage events, and processing of the disclosed software, including the maintenance application 120. Computing systems of the present invention may include a processor, which may include one or more microprocessors and/or one or more circuits, such as an application specific integrated circuit (ASIC), field-programmable gate arrays (FPGAs), etc. Further, the computing devices can include a network interface. The network interface is configured to enable communication with the network (such as the Internet), other devices and systems, and servers, using a wired and/or wireless connection.

The devices or computing systems may include memory, such as non-transitive memory, which may include one or more non-volatile storage devices and/or one or more volatile storage devices (e.g., random access memory (RAM)). In instances where the computing devices include a microprocessor, computer readable program code may be stored in a computer readable medium or memory, such as, but not limited to storage media (e.g., a hard disk or solid-state drive), memory devices (e.g., random access memory, flash memory), etc.

The computer program or software code can be stored on a tangible, or non-transitive, machine-readable medium or memory. In some embodiments, computer readable program code is configured such that when executed by a processor, the code causes the computing device to perform the steps described and depicted above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

Certain computing devices disclosed herein may include a user input device. The input device is configured to receive an input from either a user or a hardware or software component—as disclosed herein in connection with the various user interface or data inputs. Examples of an input device include a keyboard, mouse, microphone, touch screen and software enabling interaction with a touch screen, etc. The devices can also include an output device. Examples of output devices include displays, televisions, mobile device screens, tablet screens, speakers, remote screens, etc. The output device can be configured to display images, media files, text, or video, or play audio to a user through speaker output.

The disclosed cloud systems or servers 108 of the present invention can include one or more microprocessors, and/or one or more circuits, such as an application specific integrated circuit (ASIC), field-programmable gate arrays (FPGAs), etc. A network interface can be configured to enable communication with the network, using a wired and/or wireless connection, including communication with computing devices or systems disclosed herein. Memory can include one or more non-volatile storage devices and/or one or more volatile storage devices (e.g., random access memory (RAM)). In instances where the server system includes a microprocessor, computer readable program code may be stored in a computer readable medium, such as, but not limited to storage media (e.g., a hard disk or solid-state drive), memory devices, etc.

Aspects of the present invention can be embodied as software code residing on the servers 104 or other computing devices or systems, such as the meters 100, kiosks 102, and user or admin computing devices or systems (e.g., a desktop, a tablet, a smartphone, a specialized technician device, etc.). The data of the present invention can be included on and transferred to and from a storage area network (SAN), a data cloud or database, or any computing device for storing the file or files being uploaded, downloaded, or processed.

Aspects of the software code of the invention can take the form of a plugin or app, and can interface with various protocols or software using APIs or other means of interacting with computing software and systems.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

For purposes of interpreting the claims for the present invention, it is expressly intended that the provisions of 35 U.S.C. § 112(f) are not to be invoked unless the specific terms “means for” or “step for” are recited in a claim.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A parking meter monitoring system, comprising:
at least one parking meter including;
non-transitory memory;
a processor operably coupled with the non-transitory memory;
one or more meter devices;
an application policy table including one or more maintenance mode instructions; and
a software maintenance application configured to monitor the operation state of the one or more meter devices and retrieve and process the one or more maintenance mode instructions from the application policy table.

2. The system of claim 1, wherein the one or more meter devices includes a payment acceptor device.

3. The system of claim 2, wherein the payment acceptor device includes a currency acceptor device.

4. The system of claim 2, wherein the payment acceptor includes a card reader device.

5. The system of claim 1, wherein the one or more meter devices includes a meter user input device.

6. The system of claim 1, wherein the one or more meter devices includes a vehicle detection device.

7. The system of claim 7, wherein the software maintenance application puts the at least one parking meter in maintenance mode based on the application policy table.

8. The system of claim 1, wherein the at least one parking meter further includes a display configured to display a maintenance mode status.

9. The system of claim 7, wherein the maintenance mode includes out-of-operation mode.

10. The system of claim 7, wherein the software maintenance application puts the at least one parking meter from maintenance mode to operation mode.

11. The system of claim 1, further including a cloud-based server.

12. The system of claim 11, wherein the software maintenance application is in operable communication with the cloud-based server.

13. The system of claim 1, wherein the software maintenance application remotely monitors the operation state of the one or more meter devices.

14. A method of monitoring status of a parking meter, comprising:
providing an application policy database including one or more maintenance mode instructions related to one or more devices of a parking meter; and
monitoring via a software maintenance application the operation state of the one or more devices of the parking meter and retrieving and processing the one or more maintenance mode instructions from the application policy database.

15. The method of claim 14, wherein monitoring the operation state of the one or more devices of the parking meter includes monitoring a payment acceptor device.

16. The method of claim 14, wherein monitoring the operation state of the one or more devices of the parking meter includes monitoring a meter user input device.

17. The method of claim 14, wherein monitoring the operation state of the one or more devices of the parking meter includes monitoring a vehicle detection device.

18. The method of claim 14, wherein the software maintenance application puts the at least one parking meter in maintenance mode based on the application policy database.

19. The method of claim 18, wherein the software maintenance application puts the at least one parking meter from maintenance mode to operation mode.

20. The method of claim 14, wherein the software maintenance application is in operable communication with a cloud-based server and remotely monitors the operation state of the one or more devices of the at least one parking meter.
